(19) United States
(12) Patent Application Publication
(10) Pub. No.: US 2013/0039177 A1
(43) Pub. Date: Feb. 14, 2013

(54) REMOTE MOBILE COMMUNICATION SYSTEM, SERVER DEVICE AND CONTROL METHOD OF REMOTE MOBILE COMMUNICATION SYSTEM

(71) Applicant: Kazunori Ozawa, Tokyo (JP)

(72) Inventor: Kazunori Ozawa, Tokyo (JP)

(73) Assignee: NEC CORPORATION, Tokyo (JP)

(21) Appl. No.: 13/643,219

(22) PCT Filed: May 9, 2011
(86) PCT No.: PCT/JP2011/060645

§ 371 Date: Oct. 24, 2012

(30) Foreign Application Priority Data
May 10, 2010 (JP) 2010-108670

(51) Int. Cl. H04L 12/26

(52) U.S. Cl. 370/230

(57) ABSTRACT

A server device includes: a virtual client unit that causes an application program to generate screen data, based on instruction information from a mobile terminal received via a packet forwarding device in a mobile network; an encoder unit that compression-encodes an entirety or a portion of the screen data and transmits to the packet forwarding device a packet including the encoded result; and a rate control unit that measures response times of a series of response signals received from the mobile terminal with respect to the transmitted packet, and controls, based on the measurement result, at least one of a bit rate and a frame rate of the compression-encoding performed by the encoder unit.

### RELATED APPLICATION

This application claims the benefit of Japanese Patent Application No. 2010-108670, filed May 10, 2010, which is herein incorporated by reference thereto in its entirety. The invention relates to a remote mobile communication system, a server device and a control method of a remote mobile communication system, and in particular to a remote mobile communication system, a thin client server device and a control method of a remote mobile communication system, in which a mobile terminal accesses the server remotely via a mobile network to communicate with a virtual client on the server.

### TECHNICAL FIELD

### Background

Henceforth, with the progress of high speed and large capacity mobile networks due to the introduction of LTE (Long Term Evolution), EPC (Evolved Packet Core) technology, and the like, it is anticipated that new services utilizing the high speed and large capacity networks will be provided.

New services include content delivery services including, for example, 3D high definition games, large scale database search, image recognition/collation, high definition pictures (still images, videos, etc.) and high quality audio.

Patent Literature 1 describes a method of exchanging signaling information in a mobile network to optimize a rate control scheme.

Patent Literature 2 describes a color image data transmission system having optimized display quality and drawing capability in accordance with network load that changes moment by moment in a thin client based on a screen data transmission method.

### CITATION LIST

### Patent Literature

### [Patent Literature 1]

Japanese Translation of PCT International Publication, Publication No. JP2006-521029A

### [Patent Literature 2]

Japanese Patent Kokai Publication No. JP-JP2008-234389A

### SUMMARY

### Technical Problem

The various disclosures of the abovementioned Patent Literatures are incorporated herein by reference thereto. The following analysis is given by the present invention.

It may not be possible, based on a conventional service framework, to handle a situation where an operator attempts to introduce a new service, with an existing mobile terminal. In such a case, there is a problem in that, in order to handle a new service, it is necessary to purchase a new mobile terminal or to make alterations to a mobile terminal, to accompany the start of the new service.

Furthermore, in a mobile network such as a mobile packet network, an LTE/EPC network, or the like, there is a risk of bandwidth changing, depending on distance between base station and mobile device, traffic volume, and the like. However, in a case where the bit rate of information transmitted from a server does not consider these changes, packet loss occurs in the mobile network. In addition, there is a problem in that, due to the packet loss, time is required to receive information on the mobile terminal side, screen updating is slowed, the screen is disturbed, and QoE (Quality of Experience) experienced by a user deteriorates.

In addition, in mobile terminals, capability with regard to codec format, bit rate, resolution, file format and the like, differs for each type (or model). Therefore, in a case where the codec format, bit rate, screen resolution, file format or the like differ between server side and mobile terminal, there is a problem in that images cannot be displayed or cannot be decoded by the mobile terminal.

Furthermore, in a case where content such as still images or video is being viewed/listened to, and in particular when file downloading is performed, memory or storage means for temporarily storing downloaded files is necessary on the mobile terminal side. Therefore, henceforth with high speed mobile networks and when large volume files are downloaded, there is a problem in that large volume memory or storage means will be necessary in the mobile terminal.

Therefore, in a case where traffic increases in a mobile network, the prevention of deterioration in QoE experienced by a user is a problem. It is an object of the present invention to provide a server device and a control method of a remote mobile communication system that solve this problem.

### Solution to Problem

According to a first aspect of the present invention, there is provided a server device, comprising:

a virtual client unit that causes an application program to generate screen data, based on instruction information from a mobile terminal received via a packet forwarding device in a mobile network;
an encoder unit that compression-encodes an entirety or a portion of the screen data and transmits to the packet forwarding device a packet including the encoded result; and
a rate control unit that measures response times of a series of response signals received from the mobile terminal with respect to the transmitted packet, and controls, based on the measurement result, at least one of a bit rate and a frame rate of the compression-encoding performed by the encoder unit.

According to a second aspect of the present invention, there is provided a server device, comprising:

a virtual client unit that causes an application program to generate screen data, based on instruction information from a mobile terminal received via a packet forwarding device in a mobile network;
an encoder unit that compression-encodes an entirety or a portion of the screen data and transmits to the packet forwarding device a packet including the encoded result; and
a rate control unit that measures a frequency of resend requests received from the mobile terminal with respect to the transmitted packet, and controls, based on the measurement result, at least one of a bit rate and a frame rate of the compression-encoding performed by the encoder unit.

According to a third aspect of the present invention, there is provided a control method of a remote mobile communication system, comprising:

causing an application program to generating a screen data, based on instruction information from a mobile terminal received via a packet forwarding device in a mobile network;
compression-encoding an entirety or a portion of the screen data and transmitting to the packet forwarding device a packet including the encoded result; and
measuring response times of a series of response signals or frequency of resend requests, received from the mobile terminal with respect to the transmitted packet, and controlling, based on the measurement result, at least one of a bit rate and a frame rate of the compression-encoding.

### Advantageous Effects of Invention

According to the server device and the control method of a remote mobile communication system according to the present invention, in a case where traffic increases in a mobile network it is possible to prevent a decrease in QoE experienced by a user.

### BRIEF DESCRIPTION OF DRAWINGS

FIG. 1 is a diagram showing a connection configuration of devices in a remote mobile communication system according to a first exemplary embodiment;

FIG. 2 is a block diagram showing a configuration of a thin client server device in the remote mobile communication system according to the first exemplary embodiment;

FIG. 3 is a diagram showing a connection configuration of devices in a remote mobile communication system according to a second exemplary embodiment;

FIG. 4 is a block diagram showing a configuration of a thin client server device in the remote mobile communication system according to a third exemplary embodiment;

FIG. 5 is a diagram showing a connection configuration of devices in a remote mobile communication system according to a fourth exemplary embodiment;

FIG. 6 is a block diagram showing a configuration of a thin client server device in the remote mobile communication system according to the fourth exemplary embodiment; and

FIG. 7 is a diagram showing a connection configuration of devices in a remote mobile communication system according to a fifth exemplary embodiment.

### MODES

A server device according to a first developed mode may be a server device according to the abovementioned first aspect.

In a server device according to a second developed mode, in a case where an average value of the response times of the series of response signals is not less than a prescribed threshold, the rate control unit may reduce a maximum bit rate or a maximum frame rate of the compression-encoding performed by the encoder unit.

A server device according to a third developed mode may be a server device according to the abovementioned second aspect.

In a server device according to a fourth developed mode, in a case where the number of resend requests received in a prescribed time is not less than a prescribed threshold, the rate control unit may reduce a maximum bit rate or a maximum frame rate of the compression-encoding performed by the encoder unit.

In a server device according to a fifth developed mode, in a case of receiving a resend request from the mobile terminal, the rate control unit may resend a corresponding packet.

A server device according to a sixth developed mode may further comprise:

a capability table that associates and holds type and capability of a mobile terminal; and
a capability control unit that obtains capability of the mobile terminal based on type information obtained from the mobile terminal and the capability table, and controls at least one of an encoding format, a bit rate, a screen resolution, and a file format, with respect to said encoder unit, so as to conform to the obtained capability.

In a server device according to a seventh developed mode, the virtual client unit may access a Web server device or a content delivery server device on the Internet to generate the screen data.

A remote mobile communication according to an eighth developed mode may comprise:

the server device according to any one of first to seventh developed modes; and
a mobile terminal that receives a packet transmitted from the server device via the packet forwarding device, and decodes and displays an encoded result contained in the packet.

In a remote mobile communication system according to a ninth developed mode, the mobile network may be a mobile packet network or a mobile LTE/EPC (Long Term Evolution/Evolved Packet Core) network.

A control method of a remote mobile communication system according to a tenth developed mode may be a control method of a remote mobile communication system according to the above-mentioned third aspect.

According to the remote mobile communication system and server device according to the present invention, in a case where an operator introduces a new service, the new service can be introduced by updating application software of the server device disposed in a network. Therefore, it is not necessary to provide a new mobile terminal or to make alterations to a mobile terminal each time a new service is introduced.

Furthermore, according to the remote mobile communication system and server device according to the present invention, it is possible to measure response times from a mobile terminal for a case of using TCP/IP (Transmission Control Protocol/Internet Protocol), by the server device when a call connection is made or during a call connection, with respect to change in bandwidth of a mobile packet network or an LTE/EPC network, to measure the number of packet resend requests in a case of UDP/IP (User Datagram Protocol/Internet Protocol), and to control the maximum bit rate when screen information is compression-coded in accordance with a measurement result. Therefore, it is possible to avoid a deterioration in QoE due to time being required to receive information on the mobile terminal side and screen updating being delayed.

Furthermore, according to the remote mobile communication system and server device according to the present invention, the capability of the mobile terminal is obtained from type information of the mobile terminal and the capability table held by a server, and based on encoding format, bit rate, screen resolution, and file format, which conform to the capability, screen information is transmitted to the mobile terminal from the server device. Therefore, it is possible to solve a problem where an image cannot be displayed on a mobile terminal and the problem where the bit rate, resolution, codec format, file format, or the like do not conform and cannot even be decoded by the mobile terminal.

Furthermore, according to the remote mobile communication system and the server device according to the present invention, in a case where content such as still images or video is being viewed/listened to, a memory or storage means is not necessary in the mobile terminal. This will be particularly effective henceforth in a case of viewing/listening to large volume content when mobile networks are made high speed networks.

### First Exemplary Embodiment

A detailed description is given concerning a remote mobile communication system according to a first exemplary embodiment, making reference to the drawings.

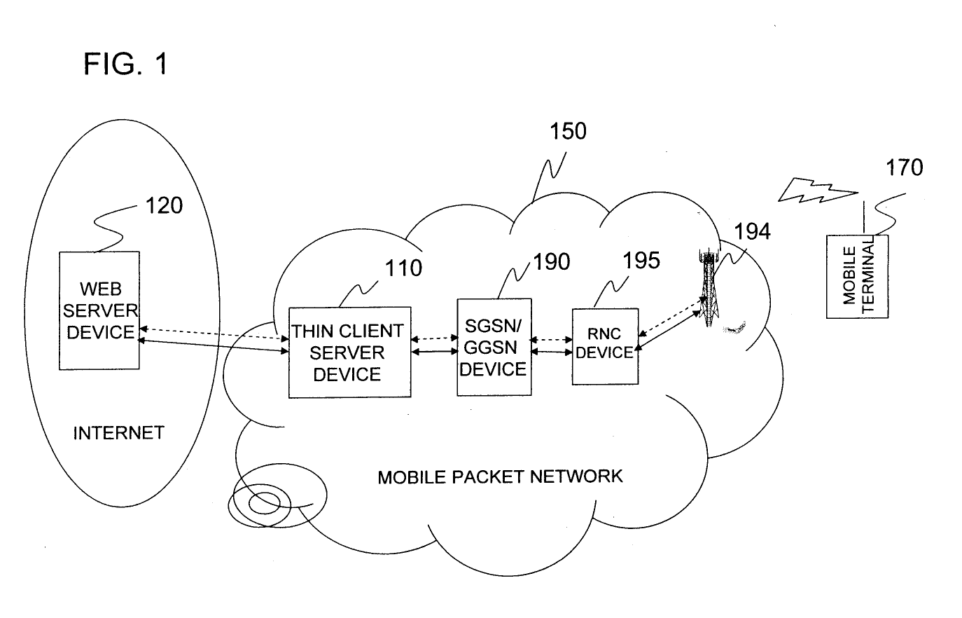

FIG. 1 is a diagram showing a connection configuration of devices in the remote mobile communication system according to the present exemplary embodiment. Referring to FIG. 1, the remote mobile communication system comprises a Web server device 120, a thin client server device 110, an xGSN (SGSN/GGSN) device 190, an RNC (Radio Network Controller) device 195, a base station 194, and a mobile terminal 170.

FIG. 1 shows a case where a mobile packet network 150 is used as a mobile network, and the xGSN device 190 is used as a packet forwarding device. Here, the xGSN device is a device in which an SGSN (Serving GPRS Support Node) device and a GGSN (Gateway GPRS Support Node) device are integrated.

FIG. 1 shows a configuration of a case in which a Web browsing service is provided to the mobile terminal 170. It is to be noted that it is possible to apply a similar configuration also in a case of providing services such as text input, email creation, content playback, games, and other new services.

In FIG. 1, the mobile terminal 170 transmits an instruction signal to the thin client server device 110, via the base station 194, the RNC device 195, and the xGSN device 190, in order to operate a virtual client of the thin client server device 110 disposed in the mobile packet network 150.

Here, an instruction signal is a signal transmitted from the mobile terminal 170 by a key operation, special character input, or the like, with respect to the mobile terminal 170.

The instruction signal transmitted from the mobile terminal 170 arrives in the sequence of the base station 194, the RNC device 195, the xGSN 190, and the thin client server device 110, provided in the mobile packet network 150. In this way, the thin client server device 110 receives the instruction signal from the mobile terminal 170.

A well known protocol can be used as a protocol for transmitting the instruction signal. Here, as an example, TCP/IP and, as an upper layer thereof, HTTP (Hypertext Transfer Protocol) are used. It is to be noted that instead of HTTP, it is possible to use SIP (Session Initiation Protocol).

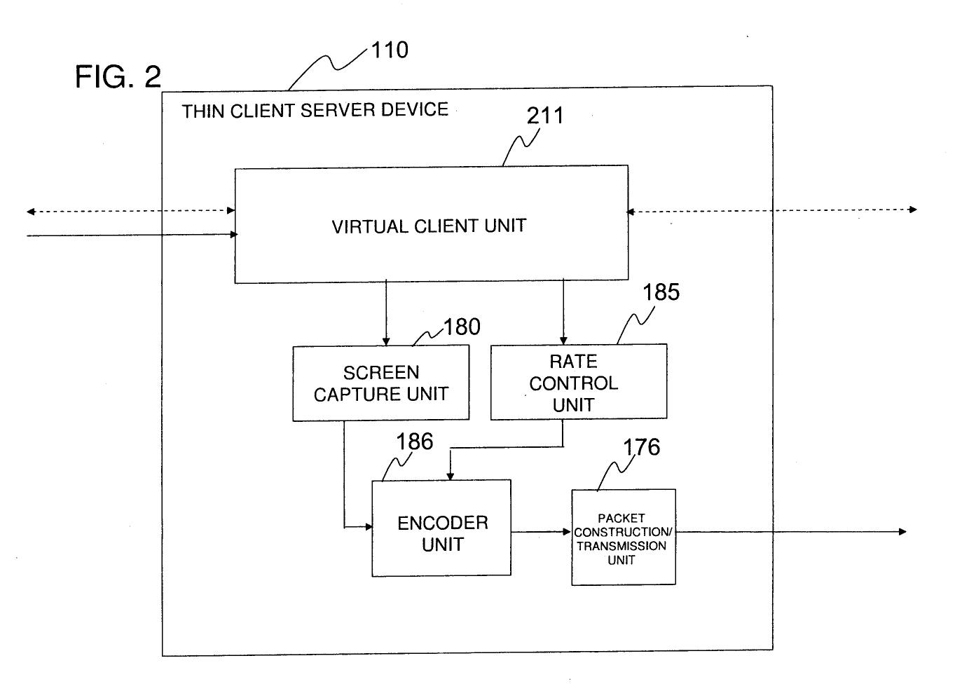

FIG. 2 is a block diagram showing a configuration of the thin client server device 110. Referring to FIG. 2, the thin client server device 110 comprises a virtual client unit 211, a screen (data) capture unit 180, an encoder unit 186, a rate control unit 185, and a packet construction/transmission unit 176.

Installed in the virtual client unit 211 are application software corresponding to a new service, a screen generation unit, a packet transmitting/receiving unit, a cache memory, a hard disk for storage, a voice/still image/video decoder, and the like (not shown in the drawing). The application software can be easily updated from outside the thin client server device 110.

The virtual client unit 211 receives a TCP packet that is an instruction signal from the mobile terminal 170, via the base station 194, the RNC device 195, and the xGSN 190. The virtual client unit 211 analyses the HTTP in the received TCP packet, and activates appropriate application software. The virtual client unit 211 analyses URL (Uniform Resource Locator) information and the like, described in the HTTP, generates a connection request if a web browser, transmits a connection request signal to a Web server device 120 on the Internet from the packet transmitting/receiving unit, and connects with the Web server device 120. Furthermore, the virtual client unit 211 receives HTML information necessary for web browsing, from the Web server device 120, generates image information in order to have a screen display, and outputs to the screen (data) capture unit 180.

The screen (data) capture unit 180 captures the screen and converts to an image luminance signal and color difference signal, and outputs to the encoder unit 186. It is to be noted that, as another format, a YUV format or the like can be used.

The encoder unit 186 receives an image signal at a predetermined fps (the number of frames per second) from the screen (data) capture unit 180. The encoder unit 186 receives input of an instruction of a maximum bit rate in a case of compression encoding from the rate control unit 185, and performs compression encoding of the image signal outputted from the screen (data) capture unit 180, such that the maximum bit rate is not exceeded, by a predetermined compression method. Furthermore, the encoder unit 186 generates a compression-encoded bit stream, and outputs to the packet construction/transmission unit 176.

The packet construction/transmission unit 176 stores the compression-encoded bit stream in a packet payload, and transmits to the xGSN device 190 using TCP/IP protocol.

It is to be noted that the packet construction/transmission unit 176 may temporarily store the compression-encoded bit stream in a file and then transmit the file in packets. As a packet protocol in this case, it is possible to use TCP/IP, for example.

The xGSN device 190 forwards a packet received by TCP/IP to the RNC device 195 using tunneling by GTP-U protocol.

The RNC device 195 transmits the forwarded packet to the mobile terminal 170 wirelessly via the base station 194.

The mobile terminal 170 receives a packet by TCP/IP protocol, and extracts a bit stream or file contained in the packet. The mobile terminal 170 possesses a decoder corresponding to the encoder unit 186 installed in the thin client server device 110. The mobile terminal 170 decodes the bit stream by this decoder, or extracts and decodes the bit stream contained in the file, and displays the decoded screen on a display-device of the mobile terminal 170.

The rate control unit 185 receives a series of response signals from the mobile terminal 170, with respect to a series of TCP packets transmitted to the mobile terminal 170, during a connection session between the thin client server device 110 and the mobile terminal 170. The rate control unit 185 measures average response time Ave(Tr(n)) in accordance with equations (1) and (2), every predetermined time period, for all or a portion of the response signals.

$$\begin{matrix}Tr ( n ) = Ack ( n ) - Ack ( n - 1 ) & ( 1 ) \\ Ave ( Tr ( n ) ) = \frac{1}{N} {\sum }_{n = 1}^{N} Tr ( n ) & ( 2 )\end{matrix}$$

In equation (1), Ack(n) represents the time at which an n-th response signal is received by the thin client server device 110. In equations (1) and (2), Tr(n) represents response time of the n-th response signal. In equation (2), Ave(Tr(n)) represents average response time, and N represents the number of response signals used in computing the average response time.

Next, the rate control unit 185 compares the average response time Ave(Tr(n)) with a predetermined threshold Th1.

Ave(Tr(n))≧Th1 (3)

In a case where equation (3) holds, the rate control unit 185 modifies the maximum bit rate Emax when encoding, in a direction of reduction, in accordance with equation (4), and give notification of the maximum bit rate Emax after reduction to the encoder unit 186.

Emax=Emax−Δ1 (4)

Here Δ1 is the predetermined bit rate reduction amount.

On the other hand, in a case where equation (5) holds, the rate control unit 185 modifies the maximum bit rate Emax when encoding, in a direction of increase, in accordance with equation (6), and give notification of the maximum bit rate Emax after increase to the encoder unit 186.

Ave(Tr(n))<Th1 (5)

Emax=Emax+Δ2 (6)

Note that the maximum bit rate Emax does not exceed MaxB.

Δ2 in equation (6) indicates the predetermined bit rate increase amount. MaxB indicates a limiting value of the maximum bit rate.

The encoder unit 186 receives the value of the maximum bit rate Emax for each predetermined time-period from the rate control unit 185, and performs coding volume control by the encoder, such that the maximum bit rate, when screen information is encoded for each frame, does not exceed Emax. Furthermore, the encoder unit 186 outputs the compression-encoded bit stream after encoding, or a file containing the compression encoded bit stream after encoding, to the packet construction/transmission unit 176.

Here, any encoding method may be used. That is, the encoding method may use a standard method such as MPEG, or may use a wavelet-based method. As a file format, it is possible to use a well known file format such as a 3GP file as specified in the 3GPP (Third Generation Partnership Project), an MP4 file, or the like.

With regard to the packet construction/transmission unit 176, a file or bit stream periodically outputted from the encoder unit 186 is received as input, and after being stored in a TCP/IP packet or a HTTP/TCP/IP packet, is outputted to the xGSN device 190.

Various types of modification are possible with regard to the configuration shown in FIG. 2. In FIG. 2, a description was given concerning a case of controlling the maximum bit rate. A configuration similar to FIG. 2 can also be applied to a case of controlling the frame rate.

### Second Exemplary Embodiment

A detailed description is given concerning a remote mobile communication system according to a second exemplary embodiment, making reference to the drawings.

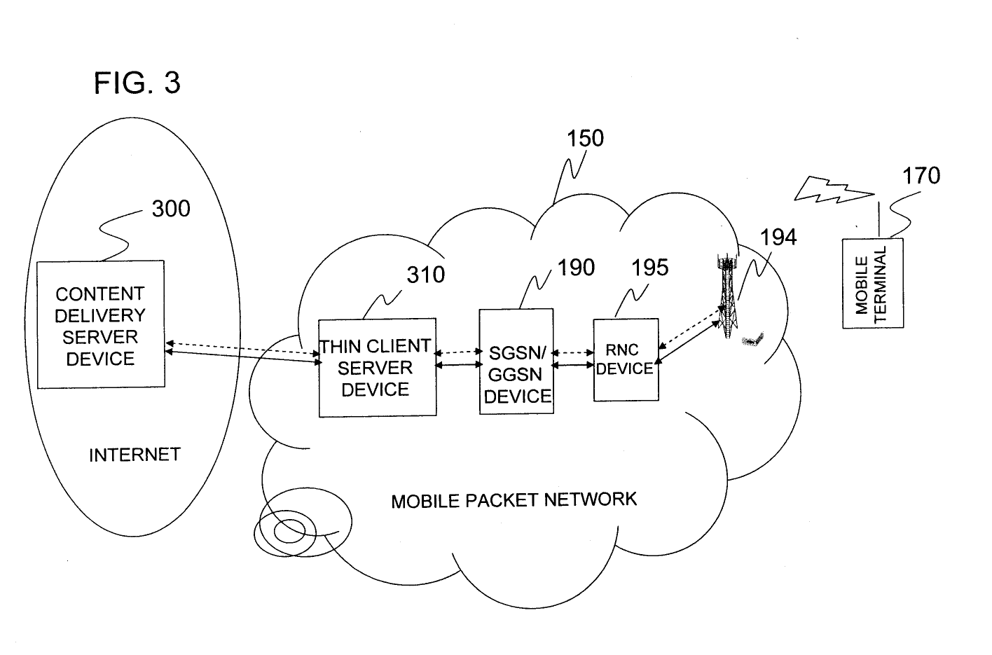

FIG. 3 is a diagram showing a connection configuration of devices in the remote mobile communication system according to the present exemplary embodiment. Referring to FIG. 3, the remote mobile communication system comprises a content delivery server device 300, a thin client server device 310, an xGSN (SGSN/GGSN) device 190, an RNC (Radio Network Controller) device 195, a base station 194, and a mobile terminal 170.

FIG. 3 shows a configuration in a case where services such as viewing/listening to content and games or the like are provided. In FIG. 3, operations of component elements having symbols the same as component elements of FIG. 1 are the same as operations of the component elements of FIG. 1, and therefore descriptions are omitted.

In FIG. 3, according to an instruction from a mobile terminal 170, the thin client server device 310 connects with the content delivery server device 300 instead of the Web server device 120 shown in FIG. 1, and reads a content file or stream that is desired to be viewed/listened to, from the content delivery server device 300.

### Third Exemplary Embodiment

A detailed description is given concerning a thin client server device according to a third exemplary embodiment, making reference to the drawings.

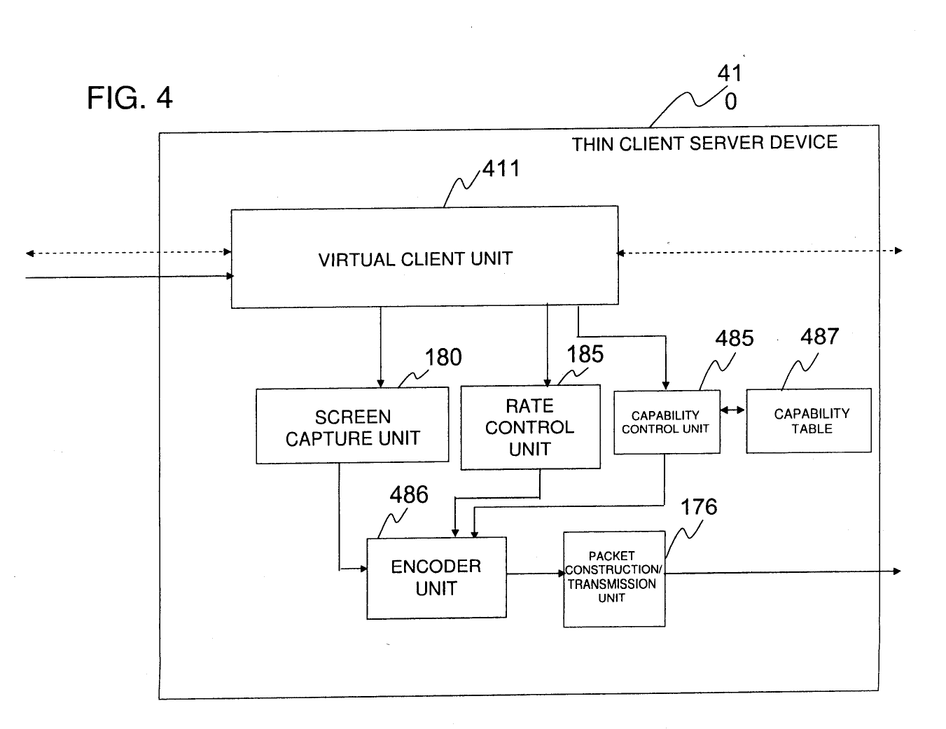

FIG. 4 is a block diagram showing a configuration of the thin client server device 410 according to the present exemplary embodiment. Referring to FIG. 4, the thin client server device 410 comprises a virtual client unit 411, a screen (data) capture unit 180, an encoder unit 486, a rate control unit 185, a packet construction/transmission unit 176, a capability control unit 485, and a capability table 487.

In the present exemplary embodiment a description is given concerning a case where a Web browser service is provided. The thin client server device 410 of the present exemplary embodiment differs from the thin client server device in the first exemplary embodiment and the second exemplary embodiment described above, with respect to the point of having the capability control unit 485 that extracts type information from a mobile terminal 170, obtains the capability of the mobile terminal 170 from the extracted type information and capability table, and performs control of at least one of encoding format, bit rate, screen resolution, and the like, with respect to the encoder unit 486, so as to conform to the obtained capability. Accordingly, a description is given concerning a configuration of the thin client server device 410 of the present exemplary embodiment.

In FIG. 4, operations of component elements having symbols the same as component elements of FIG. 2 are the same as operations of the component elements of FIG. 2, and descriptions are therefore omitted.

In FIG. 4, the capability control unit 485 receives type information of the mobile terminal 170 from the virtual client unit 411. The capability control unit 485 accesses the capability table 487 and obtains the capability of the mobile terminal 170, based on the type information of the mobile terminal 170.

Type information of the mobile terminal and the capability of the mobile terminal are recorded in the capability table 487. Here, information concerning capability includes, for example, information such as screen resolution of the mobile terminal, receivable codec type, maximum receivable bit rate, receivable file format, receivable protocol, and the like. The capability table 487 is a table that performs matching of mobile terminal type name and at least one type of the abovementioned capability information items.

The capability control unit 485 reads the capability information of the mobile terminal 170 from the capability table 487, based on the type information of the mobile terminal 170, and outputs to the encoder unit 486.

The encoder unit 486 holds various types of encoding format, screen resolution, and file format, receives at least one among the encoding format, screen resolution, and file format, from the capability control unit 485, and performing setting in the encoder unit 486. Furthermore, in a case where the screen resolution received from the screen (data) capture unit 180 is different from the screen resolution received from the rate control unit 185, the encoder unit 486 converts the resolution of the former so as to match the resolution of the latter, and performs encoding processing.

It is to be noted that in a case of application to a content service, a control unit may be added to the thin client server device 410, and in the thin client server device 410 the control unit extracts type information from the mobile terminal 170, obtains capability of the mobile terminal 170 from the extracted type information and the capability table 487, and performs control of at least one of the encoding format, bit rate, screen resolution, and the like, with respect to the encoder unit 486, so as to conform to the obtained capability.

### Fourth Exemplary Embodiment

A detailed description is given concerning a remote mobile communication system according to a fourth exemplary embodiment, making reference to the drawings.

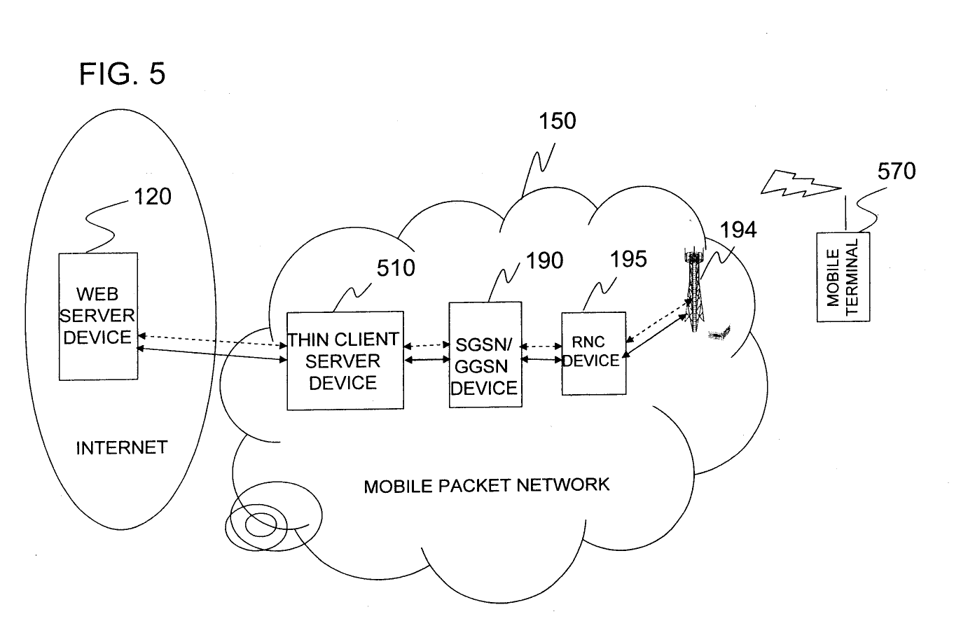

FIG. 5 is a diagram showing a connection configuration of devices in the remote mobile communication system according to the present exemplary embodiment. Referring to FIG. 5, the remote mobile communication system comprises a Web server device 120, a thin client server device 510, an xGSN (SGSN/GGSN) device 190, an RNC device 195, a base station 194, and a mobile terminal 570.

In the first to third exemplary embodiments, a description was given of cases where TCP/IP is used as a packet protocol that transmits from a thin client server device to the xGSN device 190. In the present exemplary embodiment, a description is given concerning a case where UDP/IP is used instead of TCP/IP.

By using UDP/IP, it is possible to shorten forwarding delay time in a mobile network, in comparison with a case where TCP/IP is used. On the other hand, in a case of using UDP/IP, a counter-measure is necessary with regard to packet loss.

Here, a description is given of a case where a decision is made as to whether or not packet loss has occurred on a mobile terminal side, and in the case where packet loss has occurred, a request to resend the packet is made to the thin client server device from the mobile terminal.

In FIG. 5, operations of component elements having symbols the same as component elements of FIG. 1 are the same as operations of the component elements of FIG. 1, and therefore descriptions are omitted.

The configuration shown in FIG. 5 differs from the configuration shown in FIG. 1 in the following points (1) to (3). (1) The thin client server device 510 transmits a UDP/IP packet to the xGSN device 190. (2) Its own sequence number or a generic sequence number is attached to the UDP packet. (3) The mobile terminal 570 receives the UDP/IP packet transmitted from the thin client server device 510 via the xGSN device 190, the RNC device 195, and the base station 194.

The mobile terminal 570 checks its own or a generic sequence number attached to the UDP/IP packet, and confirms whether or not there is packet loss in the UDP packet. In a case where the sequence number is continuous and there is no packet loss, the mobile terminal 570 extracts a file or bit stream contained in a payload unit of the UDP packet, and after performing decoding, displays on a display-device of the mobile terminal 570. On the other hand, in a case where the sequence number jumps (is non-continuous), and packet loss is considered to have occurred, the mobile terminal 570 requests resending of the packet for which loss has occurred, with respect to the thin client server device 510.

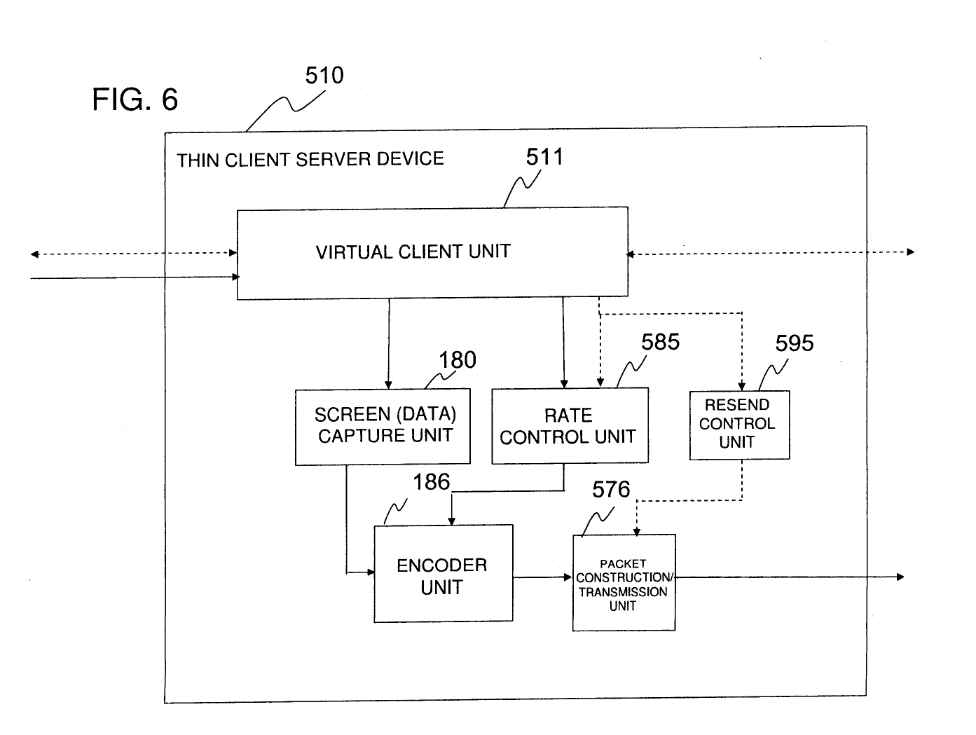

FIG. 6 is a block diagram showing a configuration of the thin client server device 510. Referring to FIG. 6, the thin client server device 510 comprises a virtual client unit 511, a screen (data) capture unit 180, an encoder unit 186, a rate control unit 585, a packet construction/transmission unit 576, and a resend control unit 595.

In FIG. 6, operations of component elements having symbols the same as component elements of FIG. 2 are the same as operations of the component elements of FIG. 2, and therefore descriptions are omitted.

Referring to FIG. 6, the packet construction/transmission unit 576 stores a compression-encoded bit stream in a UDP packet payload, attaches its own or a generic sequence number, and uses UDP/IP protocol to transmit to the xGSN device 190.

It is to be noted that the packet construction/transmission unit 576 may temporarily store the compression-encoded bit stream in a file and may then transmit the file in packets. As a packet protocol in this case, it is possible to use TCP/IP, for example.

In a case where the mobile terminal 570 requests resending, the resend control unit 595 receives a resend request instruction from the virtual client unit 511 via the xGSN device 190. The resend control unit 595 identifies the sequence number from the resend request instruction, and outputs the identified sequence number to the packet construction/transmission unit 576.

The packet construction/transmission unit 576, in accordance with an instruction from the resend control unit 595 resends the UDP/IP packet with the relevant sequence number to the xGSN device 190.

The rate control unit 585 counts the number of resend request instructions received from the virtual client unit 511 within a predetermined time interval, and obtains a cumulative value C for the predetermined time interval. By comparing the obtained cumulative value C with a predetermined threshold Th2, the rate control unit 585 controls the maximum bit rate Emax for the encoder unit 186.

C≧Th2 (7)

Where equation (7) holds, the rate control unit 585 reduces the maximum bit rate Emax as in equation (8).

Emax=Emax−Δ3 (8)

In equation (8), Δ3 is a predetermined constant.

On the other hand, where the accumulated value C is less than the threshold Th2, the rate control unit 585 returns the maximum bit rate Emax to its initial value.

The rate control unit 585 outputs the maximum bit rate Emax obtained in this way to the encoder unit 186.

In FIG. 6, a description was given concerning a case of controlling the maximum bit rate. A configuration similar to FIG. 6 can also be applied to a case of controlling the frame rate.

It is to be noted that in FIG. 5 and FIG. 6, a description was given concerning a case of Web browsing. The configuration of the present exemplary embodiment shown in FIG. 5 and FIG. 8 can also be applied to a case of providing services for viewing/listening to still images or video content, and services for games or the like. In this case, with regard to FIG. 5, a content delivery server device 300 described in FIG. 3 may be used, instead of a Web server device 120.

In addition, type information may be extracted from the mobile terminal, the capability of the mobile terminal may be obtained from the type information and a capability table, and control may be performed of at least one of the encoding format, bit rate and screen resolution with respect to the encoder unit 186. In a case of implementing the relevant control, a capability control unit 485 and a capability table 487, which are shown in FIG. 4, may be added to FIG. 6.

### Fifth Exemplary Embodiment

A detailed description is given concerning a remote mobile communication system according to a fifth exemplary embodiment, making reference to the drawings.

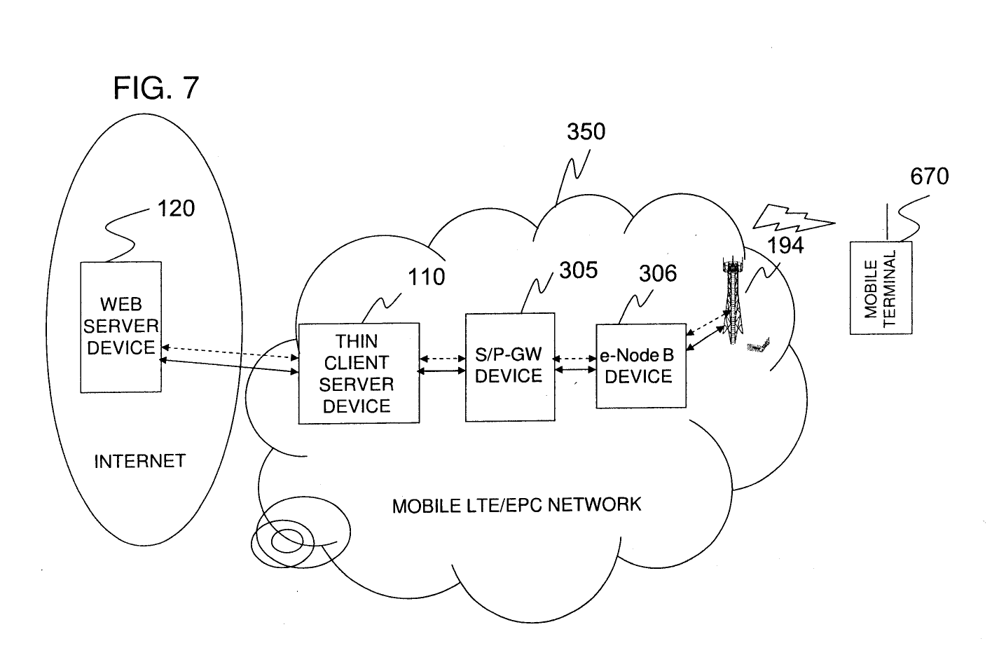

FIG. 7 is a diagram showing a connection configuration of devices in the remote mobile communication system according to the present exemplary embodiment. Referring to FIG. 7, the remote mobile communication system comprises a Web server device 120, a thin client server device 110, an S/P-GW device 305, an e-NodeB (enhanced-NodeB) device 306, a base station 194, and a mobile terminal 670.

In FIG. 7, operations of component elements having symbols the same as component elements of FIG. 1 are the same as operations of the component elements of FIG. 1, and therefore descriptions are omitted.

The configuration shown in FIG. 7 and the configuration shown in FIG. 1 differ in the point that the mobile terminal 670 is connected to a thin client server device 110 via the e-NodeB device 306 and the S/P-GW device 305, through a mobile LTE/EPC network 350. According to the configuration shown in FIG. 7, it is possible to forward packets at much higher speeds in comparison to a configuration based on the mobile packet network 150 shown in FIG. 1.

The e-NodeB device 306 realizes packet transmission at much higher speeds in comparison to a conventional case, in a wireless zone with the mobile terminal 670, using LTE technology. Since the S/P-GW device 305 and the thin client server device 110 are connected by IP protocol, in a case of connecting with the S/P-GW device 305 also, it is possible to use the thin client server device 110 shown in FIG. 1 as it is.

The S/P-GW device 305 receives a packet by TCP/IP or UDP/IP protocol or a file forwarded according to these protocols from the thin client server device 110, and after converting to GTP-U (GPRS Tunneling Protocol-User Plane)/TCP/IP or GTP-U/UDP/IP protocol, outputs a compression encoded bit stream or file to the e-NodeB device 306.

The e-NodeB device 306 converts to PDCP/RLC (Packet Data Convergence Protocol/Radio Link Control) protocol and transmits a packet or a file to the mobile terminal 670.

In the present exemplary embodiment it is possible to include each component element included in the configurations of the abovementioned first to fourth exemplary embodiments, or combinations thereof. Furthermore, the S/P-GW device 305 may be arranged by being separated into an S-GW device and a P-GW device.

Furthermore, in all of the exemplary embodiments described above, it is possible to use SIP, SDP or the like, as response signals from the mobile terminal.

According to the remote mobile communication system and thin client server device according to the abovementioned exemplary embodiments, in a case where an operator introduces a new service, the new service can be introduced by updating application software of the thin client server device arranged in a network. Therefore, it is not necessary to provide a new mobile terminal or to make alterations to a mobile terminal, each time a new service is introduced.

Furthermore, according to the remote mobile communication system and thin client server device according to the above-mentioned exemplary embodiments, it is possible to measure response time from a mobile terminal for a case of TCP/IP, by the thin client server device when a call connection is made or during a call connection, with respect to a change in bandwidth of a mobile packet network or an LTE/EPC network, to measure the number of packet resend requests in a case of UDP/IP, and to control the maximum bit rate when screen information is compression-encoded in accordance with a measurement result. Therefore, it is possible to avoid a deterioration in QoE due to time being required to receive information on the mobile terminal side and screen updating being delayed.

Furthermore, according to the remote mobile communication system and thin client server device according to the above-mentioned exemplary embodiment, the capability of the mobile terminal is obtained from type information of the mobile terminal and the capability table held by a server, and based on encoding format, bit rate, screen resolution, and file format, that conform to the capability, screen information is forwarded to the mobile terminal from the thin client server device. Therefore, it is possible to solve a problem where an image cannot be displayed on the mobile terminal and the problem where the bit rate, resolution, codec format, file format, or the like do not conform and cannot be even decoded by the mobile terminal.

Furthermore, according to the remote mobile communication system and the thin client server device according to the abovementioned exemplary embodiments, in a case where content such as a still images or video is being viewed/listened to, a memory or storage means is not necessary in the mobile terminal. This will be particularly effective henceforth in a case of viewing/listening to content of large volume when mobile networks are made high speed.

Modifications and adjustments of exemplary embodiments are possible within the bounds of the entire disclosure (including the scope of the claims) of the present invention, and also based on fundamental technological concepts thereof. Furthermore, a wide variety of combinations and selections of various disclosed elements is possible within the scope of the claims of the present invention. That is, the present invention clearly includes every type of transformation and modification that a person skilled in the art can realize according to the entire disclosure including the scope of the claims and to technological concepts thereof.

Furthermore, some or all of the abovementioned exemplary embodiments can be described as in the following appendices but there is no limitation thereto.

### APPENDIX 1

A thin client server device, comprising:
a virtual client unit that causes an application program to generate screen data, based on instruction information from a mobile terminal received via a packet forwarding device in a mobile network;
an encoder unit that compression-encodes an entirety or a portion of the screen data and transmits to the packet forwarding device a packet including the encoded result; and
a rate control unit that measures response times of a series of response signals received from the mobile terminal with respect to the transmitted packet, and controls, based on the measurement result, at least one of a bit rate and a frame rate of the compression-encoding performed by the encoder unit.

### APPENDIX 2

The thin client server device according to appendix 1, wherein in a case where an average value of the response times of the series of response signals is not less than a prescribed threshold, the rate control unit reduces a maximum bit rate or a maximum frame rate of the compression-encoding performed by the encoder unit.

### APPENDIX 3

The thin client server device according to appendix 1 or 2, wherein the encoder unit transmits a packet including the encoded result to the packet forwarding device based on TCP protocol.

### APPENDIX 4

A thin client server device, comprising:
a virtual client unit that causes an application program to generate screen data, based on instruction information from a mobile terminal received via a packet forwarding device in a mobile network;
an encoder unit that compression-encodes an entirety or a portion of the screen data and transmits to the packet forwarding device a packet including the encoded result; and
a rate control unit that measures a frequency of resend requests received from the mobile terminal with respect to the transmitted packet, and controls, based on the measurement result, at least one of a bit rate and a frame rate of the compression-encoding performed by the encoder unit.

### APPENDIX 5

The thin client server device according to appendix 4, wherein
in a case where the number of resend requests received in a prescribed time is not less than a prescribed threshold, the rate control unit reduces a maximum bit rate or a maximum frame rate of the compression-encoding performed by the encoder unit.

### APPENDIX 6

The thin client server device according to appendix 4 or 5, wherein in a case of receiving a resend request from the mobile terminal, the rate control unit resends a corresponding packet.

### APPENDIX 7

The server device according to any one of appendices 4 to 6, wherein the encoder unit transmits a packet including the encoded result as a packet to the packet forwarding device based on UDP protocol.

### APPENDIX 8

The thin client server device according to any one of appendices 1 to 7, further comprising:
a capability table that associates and holds type and capability of a mobile terminal; and
a capability control unit that obtains capability of the mobile terminal based on type information obtained from the mobile terminal and the capability table, and controls at least one of an encoding format, a bit rate, a screen resolution, and a file format, with respect to said encoder unit, so as to conform to the obtained capability.

### APPENDIX 9

The thin client server device according to any one of appendices 1 to 8, wherein
the virtual client unit accesses a Web server device on the Internet to generates the screen data.

### APPENDIX 10

The thin client server device according to any one of appendices 1 to 8, wherein
the virtual client unit accesses a content delivery server device on the Internet to generate the screen data.

### APPENDIX 11

A remote mobile communication system, comprising:
the thin client server device according to any of appendices 1 to 10.

### APPENDIX 12

The remote mobile communication system according to appendix 11, further comprising:
a mobile terminal that receives a packet transmitted from the server device via the packet forwarding device, and decodes and displays an encoded result contained in the packet.

### APPENDIX 13

The remote mobile communication system according to appendix 11 or 12, wherein
the mobile network is a mobile packet network or a mobile LTE/EPC (Long Term Evolution/Evolved Packet Core) network.

### APPENDIX 14

A control method of a remote mobile communication system, comprising:
causing an application program to generate a screen data, based on instruction information from a mobile terminal received via a packet forwarding device in a mobile network;
compression-encoding an entirety or a portion of the screen data and transmitting to the packet forwarding device a packet including the encoded result; and
measuring response times of a series of response signals received from the mobile terminal with respect to the transmitted packet, and controlling, based on the measurement result, at least one of a bit rate and a frame rate of the compression-encoding.

### APPENDIX 15

The control method according to appendix 14, further comprising:
in a case where an average value of the response times of the series of response signals is not less than a prescribed threshold, reducing a maximum bit rate or a maximum frame rate of the compression encoding.

### APPENDIX 16

A control method of a remote mobile communication system, comprising:
causing an application program to generate a screen data, based on instruction information from a mobile terminal received via a packet forwarding device in a mobile network;
compression-encoding an entirety or a portion of the screen data and transmitting to the packet forwarding device a packet including the encoded result; and
measuring frequency of resend requests received from the mobile terminal with respect to the transmitted packet, and controlling, based the measurement result, at least one of a bit rate and a frame rate of the compression-encoding.

### APPENDIX 17

The control method according to appendix 16, further comprising:
in a case where the number of resend requests received in a prescribed time is not less than a prescribed threshold, reducing a maximum bit rate or a maximum frame rate of the compression-encoding.

### REFERENCE SIGNS LIST

110, 310, 410, 510 thin client server device (server device)
120 Web server device
150 mobile packet network
170, 570, 670 mobile terminal
176, 576 packet construction/transmission unit
180 screen (data) capture unit
185, 585 rate control unit
186, 486 encoder unit
190 xGSN (SGSN/GGSN) device
194 base station
195 RNC device
211, 411, 511 virtual client unit
300 content delivery server device
305 S/P-GW device
306 e-NodeB device
350 mobile LTE/EPC network
485 capability control unit
487 capability table
585 rate control
595 resend control unit

1. A server device, comprising:
a virtual client unit that causes an application program to generate screen data, based on instruction information from a mobile terminal received via a packet forwarding device in a mobile network;
an encoder unit that compression-encodes an entirety or a portion of the screen data and transmits to the packet forwarding device a packet including the encoded result; and
a rate control unit that measures response times of a series of response signals received from the mobile terminal with respect to the transmitted packet, and controls, based on the measurement result, at least one of a bit rate and a frame rate of the compression-encoding performed by the encoder unit.

2. The server device according to claim 1, wherein
in a case where an average value of the response times of the series of response signals is not less than a prescribed threshold, the rate control unit reduces a maximum bit rate or a maximum frame rate of the compression-encoding performed by the encoder unit.

3. A server device, comprising:
a virtual client unit that causes an application program to generate screen data, based on instruction information from a mobile terminal received via a packet forwarding device in a mobile network;
an encoder unit that compression-encodes an entirety or a portion of the screen data and transmits to the packet forwarding device a packet including the encoded result; and
a rate control unit that measures a frequency of resend requests received from the mobile terminal with respect to the transmitted packet, and controls, based on the measurement result, at least one of a bit rate and a frame rate of the compression-encoding performed by the encoder unit.

4. The server device according to claim 3, wherein
in a case where the number of resend requests received in a prescribed time is not less than a prescribed threshold, the rate control unit reduces a maximum bit rate or a maximum frame rate of the compression-encoding performed by the encoder unit.

5. The server device according to claim 3, wherein
in a case of receiving a resend request from the mobile terminal, the rate control unit resends a corresponding packet.

6. The server device according to claim 1, further comprising:
a capability table that associates and holds type and capability of a mobile terminal; and
a capability control unit that obtains capability of the mobile terminal based on type information obtained from the mobile terminal and the capability table, and controls at least one of an encoding format, a bit rate, a screen resolution, and a file format, with respect to said encoder unit, so as to conform to the obtained capability.

7. The server device according to claim 1, wherein
the virtual client unit accesses a Web server device or a content delivery server device on the Internet to generate the screen data.

8. A remote mobile communication system, comprising:
the server device according to claim 1; and
a mobile terminal that receives a packet transmitted from the server device via the packet forwarding device, and decodes and displays an encoded result contained in the packet.

9. The remote mobile communication system according to claim 8, wherein
the mobile network is a mobile packet network or a mobile LTE/EPC (Long Term Evolution/Evolved Packet Core) network.

10. A control method of a remote mobile communication system, comprising:
causing an application program to generate a screen data, based on instruction information from a mobile terminal received via a packet forwarding device in a mobile network;
compression-encoding an entirety or a portion of the screen data and transmitting to the packet forwarding device a packet including the encoded result; and
measuring response times of a series of response signals or frequency of resend requests, received from the mobile terminal with respect to the transmitted packet, and controlling, based on the measurement result, at least one of a bit rate and a frame rate of the compression-encoding.

11. The control method according to claim 10, further comprising:
in a case where an average value of the response times of the series of response signals is not less than a prescribed threshold, reducing a maximum bit rate or a maximum frame rate of the compression encoding.

12. A control method of a remote mobile communication system, comprising:
causing an application program to generate a screen data, based on instruction information from a mobile terminal received via a packet forwarding device in a mobile network;
compression-encoding an entirety or a portion of the screen data and transmitting to the packet forwarding device a packet including the encoded result; and
measuring frequency of resend requests received from the mobile terminal with respect to the transmitted packet, and controlling, based the measurement result, at least one of a bit rate and a frame rate of the compression-encoding.

13. The control method according to claim 12, further comprising:
in a case where the number of resend requests received in a prescribed time is not less than a prescribed threshold, reducing a maximum bit rate or a maximum frame rate of the compression-encoding.

14. The server device according to claim 3, further comprising:
A capability table that associates and holds type and capability of a mobile terminal; and
A capability control unit that obtains capability of the mobile terminal based on type information obtained from the mobile terminal and the capability table, and controls at least one of an encoding format, a bit rate, a screen resolution, and a file format, with respect to said encoder unit, so as to conform to the obtained capability.

15. The server device according to claim 3, wherein
the virtual client unit accesses a Web server device or a content delivery server device on the Internet to generate the screen data.

16. A remote mobile communication system, comprising:
the server device according to claim 3; and
a mobile terminal that receives a packet transmitted from the server device via the packet forwarding device, and decodes and displays an encoded result contained in the packet.

17. The remote mobile communication system according to claim 16, wherein
the mobile network is a mobile packet network or a mobile LTE/EPC (Long Term Evolution/Evolved Packet Core) network.
